(19) United States
(12) Patent Application Publication
(10) Pub. No.: US 2017/0140338 A1
(43) Pub. Date: May 18, 2017

(54) METHOD TO AUTOMATICALLY CREATE COLLABORATION GROUPS USING MULTIFACTOR RELATIONSHIP DATA PROVIDED BY USERS AND SYSTEMS

(71) Applicant: DELL PRODUCTS L.P., Round Rock, TX (US)

(72) Inventors: Tom Willis, Madison, WI (US); Chad Lindley, Mt. Horeb, WI (US)

(21) Appl. No.: 14/942,776

(22) Filed: Nov. 16, 2015

(51) Int. Cl. G06Q 10/10; H04L 29/08; H04L 12/58

(52) U.S. Cl. CPC G06Q 10/103; H04L 51/22; H04L 67/306; G06Q 10/1093

(57) ABSTRACT

A system processing data comprising a plurality of relationship data sources. A migration engine operating on a processor or processors and coupled to the plurality of relationship data sources, the migration engine configured to query the plurality of relationship data sources and to receive query responses from the plurality of relationship data sources. A relationship analysis engine operating on the processor or processors and coupled to the migration engine, the relationship analysis engine configured to receive the query response and to process the query responses to extract prospective collaboration data. A target application configured to receive the prospective collaboration data and to configure a user profile with the prospective collaboration data.

### TECHNICAL FIELD

The present disclosure relates generally to enterprise software, and more specifically to systems and methods for creating collaboration groups using multifactor relationship data provided by users and systems.

### BACKGROUND OF THE INVENTION

Microsoft Office 365 is a dynamic collaboration tool that enables end users to collaborate and communicate with their colleagues and partners using email, shared files, discussion boards, IM and other collaboration tools, without the IT process overhead of traditional distribution lists and centrally managed collaboration spaces, such as SharePoint. In contrast with IT-managed security groups and distribution lists, the new Office 365 Groups are meant to be easy to setup and managed by regular information workers. These groups will simplify collaboration between information workers and provide data-persistence so new members to the group will have access to the historical content and activity of the group.

### SUMMARY OF THE INVENTION

A system for processing data is provided that includes a plurality of relationship data sources, such as emails from an email software application. A migration engine operating on a processor or processors can query the relationship data sources, such to gather delegation and access control information. A relationship analysis engine receives the data and processes it to extract prospective collaboration data and present recommended collaboration group membership based on the results. A target software application, such as a new email software application, in which the migration engine provisions the approved collaboration groups and membership names, such as to allow the user to readily use the new email software application.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of a system for processing system migration data, in accordance with an exemplary embodiment of the present disclosure;

FIG. 2 is a diagram of a user interface for processing system migration data, in accordance with an exemplary embodiment of the present disclosure;

FIG. 3 is a flow chart of an algorithm for processing system migration data, in accordance with an exemplary embodiment of the present disclosure; and

FIG. 4 is a diagram of application analysis engines, in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

Applications such as Microsoft Office 365 provide collaboration tools to enable end users to efficiently collaborate and communicate with their colleagues and partners using email, shared files, discussion boards, instant messaging (IM) and other software applications, without the heavy IT process overhead of traditional, on-premises collaboration platforms. In contrast with IT-managed security groups and distribution lists, Office 365 Groups are meant to be easy to setup and manage by regular information workers. While the process of creating groups is relatively straightforward, understanding which persons should be included in each group is a challenge and one that is addressed by this disclosure. Nevertheless, such new collaboration tools suffer from the unforeseen drawback of users not knowing appropriate membership lists for the Office 365 Groups in order to optimize participation and maximize the results.

For example, the process of identifying individuals whose data (email, social, SharePoint, archives, files, etc.) and/or identities are related within the source environment and thus should be included in corresponding Office 365 groups would be a difficult and time-consuming process if attempted manually. The techniques discussed herein can be applied to the creation of optimal Office 365 Groups as part of the migration process, based on analysis of relationship data provided by users and computer systems like electronic directories and other data sources.

During the migration process, when an organization moves from legacy platforms for email, calendaring, document management and other collaboration tools to the Office 365 cloud or new collaboration tools, the benefit that migrating organizations and their users will derive from their new collaboration platform can be enhanced by taking advantage of new value-adding features, such as Office 365 Groups or similar features of other collaboration tools. The present disclosure provides mechanisms for creating suggestions for such new Office 365 Groups during migration, based on the analysis of relationships from existing applications, such as email applications, calendar applications, document management applications, social networking applications or the like.

It is anticipated that other collaboration platforms such as the IBM Domino/Connections/Verse applications and Google App email and collaboration platforms will also implement similar grouping concepts, and that the migration solutions disclosed herein could be implemented with those applications as well. The term “Office 365 Group” will be used throughout this disclosure, but could equally apply to analogous dynamic, user-oriented collaboration groups on other email and collaboration platforms.

Sufficient relationship data can be inferred from the data within source applications to create groups of users who collaborate together, such as from information stored in the email and directory systems themselves, delegation and organizational chart relationships in human resources (HR) databases, and other suitable data sources. Methods for gathering and analyzing such relationship data are also disclosed in U.S. application Ser. No. 14/588,181, entitled “EMAIL AND IDENTITY MIGRATION BASED ON RELATIONSHIP INFORMATION,” which is commonly owned with the present application and is hereby incorporated by reference for all purposes, as if set forth herein in its entirety. However, many enterprises do not use mailbox and calendar delegation enough for those applications to provide sufficient grouping relationships. Cross-functional groups who work together and their relationships may also not be expressed in an organizational chart. The present disclosure identifies important collaboration groups during a migration process, such as by asking end users for input, collating that input, and processing the results to create new proposed collaboration group membership lists. The present disclosure allows the weighting of relationships, the weighted summation of multiple relationship factors to determine the proposed group membership of users, and other ways of gathering relationship information for a social relationship graph or other suitable processes.

In addition, relationship data can be automatically collected from the documents being migrated. As emails, meetings, tasks, contacts and other documents are migrated, working relationships can be inferred from the content of the documents. For example, if a user has a contact for another user in their personal address book, that contact indicates a working relationship, which can be added to the multifactor social graph. Likewise, co-workers who attend meetings with each other may have important working relationships, and these data can also be added to the relationship graph. Frequent sending and receipt of email can also indicate a relationship between the coworkers, and can be added to the relationship network. These factors and other suitable data in the migrated content can be used to supplement the relationship data set with appropriate weighting factors, which can be used by the migration administrator or others to generate collaboration group data.

Once information is collected from end users or other data sources, it is used to build a relationship graph or other suitable tools, and processed in a grouping engine. End users can be prompted to provide input or to review relationship data.

Since users collaborate in enterprise social networking applications like SharePoint, Jive or Yammer, collaboration relationship data can also be discovered based on membership in such groups, interactions between users in discussions, common editing of the same document and so forth. While the processes for gathering data from all such applications are not addressed herein, the same process as is used for applications that are disclosed herein can also or alternatively be used. Optionally, other relationship data can be included into the weighting of the relationship links, from sources such as mentorship relationships derived from a HR database, mail sending frequency relationships derived from an application such as Dell MessageStats/UCCS, delegation and organizational chart relationships, or other suitable data.

Sources for relationship data can include the access control list (ACL), shared permissions, and delegation data stored in the source mail system, mail message address data stored in the source mail message document database, distribution list relationships stored in the electronic directory, organizational chart relationships stored in the HR database, collaboration activities stored in a database associated with applications such system like SharePoint, results of surveys of users and other suitable data sources. The relationship data can be collected by discovery applications and returned to the migration solution engine, which can store the data in a suitable relationship database. A migration graphical user interface (GUI) can present a list of proposed relationship settings for the collaboration groups and these recommendations can be added, deleted or otherwise modified. The collaboration groups can then be provisioned and will be ready for the end users after migration.

In one exemplary embodiment, the input data can be weighted by a migration administrator, migration consultant or other suitable users, to generate an aggregate social graph with weighted edges (edge cost), or other suitable analytical tools. The edge cost can be calculated from weighted sums, such as:

CE=Σwi*Ci

### CE—Edge Cost

wi—weighting factor of relationship type i
Ci—value of relationship of type I between the two nodes

From this weighted social graph, proposed Office 365 Group membership lists can be created by applying social network analysis techniques, including but not limited to “n-clan/n-clique” or “k-plex/k-core” analysis, as commonly known to social network analysis. In one exemplary embodiment, NodeXL software can be used to split a weighted social graph into smaller clusters, or other suitable processes can also or alternatively be used.

In addition, the following features can be used as part of the migration process:
Discovery applications that gather relationship data (application-specific) automatically from applications (email server, directory, SharePoint, HR database).
A survey application that gathers relationship data (application-specific) from users (self-service).
Storage of the relationship network with a database (potentially application-specific)
Creation of a collection list from the relationship network data, potentially given starting point (seed), traversal depth and maximum count limit, which can be configurable (common component)
Extraction of relationship data from mailbox data as it is migrated.
Display of suggested memberships for Office 365 Groups to a migration administrator or other suitable users (application-specific for existing solutions, such as using a common interchange e.g. tab-separated values (TSV))
Modification of suggested memberships
Provisioning capabilities to create the derived Office 365 Groups in Office 365 (Azure Active Directory) as part of the migration process.

These functionalities can be shared across multiple migration solutions, with common components that are used by the existing solutions, those leveraging the present disclosure, those using older and newer technologies (C++, C#, JavaScript), and other suitable applications. Examples of the present disclosure are mostly described in terms of email, calendar and document management system migration, but would apply equally to SharePoint, enterprise social or other IT migration processes where there is relationship data of any suitable kind that can be used to build modern dynamic collaboration groups like Office 365 Groups.

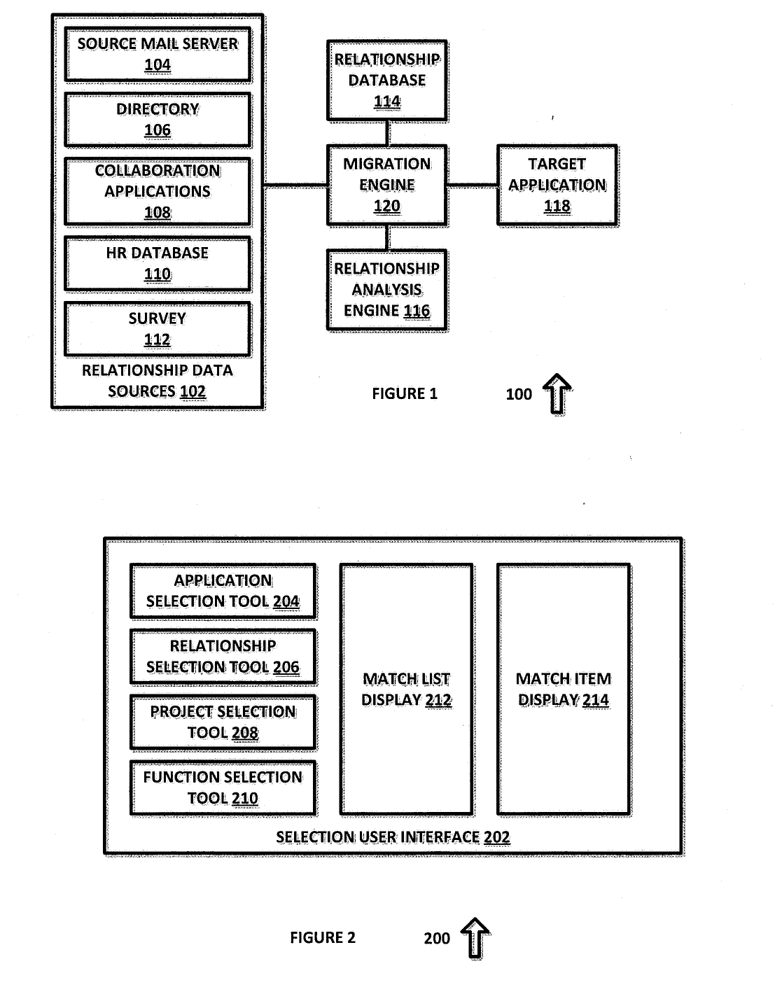

FIG. 1 is a diagram of a system 100 for processing system migration data, in accordance with an exemplary embodiment of the present disclosure. System 100 includes relationship data sources 102, which further include source mail server 104, directory 106, collaboration applications 108, HR database 110, survey 112, migration engine 120, relationship database 114, relationship analysis engine 116 and target application 118, each of which can be implemented in hardware or a suitable combination of hardware and software.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes a microcomputer or other suitable controller, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections.

Relationship data sources 102 include source mail server 104, directory 106, collaboration applications 108, HR database 110, survey 112 and other suitable data sources, such as those derived from existing applications that include data that can be used to identify collaborative relationships between users. Relationship data sources 102 typically include an associated user and contact data for other users, such as email addressee data from mail server 104, organizational relationship data from directory 106, work group data from collaboration applications 108, mentor-mentee relationship data from HR database 110, user data from survey 112 and other suitable data. Although exemplary relationship data sources have been provided, other suitable data sources can also or alternatively be used.

Migration engine 120 receives relationship data from relationship data sources 102 and coordinates the processing of the data by relationship analysis engine 116 for storage in relationship database 114 and provisioning of target application 118. In one exemplary embodiment, migration engine 112 can generate one or more queries for data sources such as relationship data sources 102 to obtain relational data that can be used to identify collaboration groups, and can provide the data to relationship analysis engine 116 or other suitable sources. Likewise, the relational data that has been processed by relationship analysis engine 116 can be used by migration engine 112 to provision a target application, such as Microsoft Office 365 or other suitable applications, and can be stored in relationship database 114 or other suitable locations.

Relationship database 114 stores relationship data for migration support or other operational purposes. In one exemplary embodiment, data for migration support from an existing application or suite of applications can be extracted and stored in relationship database 114, records for specific users can be stored in relationship database 114 during processing, or other suitable data can also or alternatively be stored.

Relationship analysis engine 116 applies one or more processes or algorithms to data from relationship data sources to extract and classify relationship data. In one exemplary embodiment, email data can be analyzed to identify data having collaborative indications, such as addressee data (from, to, cc:, bcc:, distribution list membership and so forth), client numbers, matter numbers, header data or other suitable data, the number of emails associated with such data can be tabulated, the email data can be correlated to data from other data sources such as organization charts or other suitable processing can also or alternatively be performed. In another exemplary embodiment, calendar data can be analyzed to identify data having collaborative indications, such as meeting attendee data, client numbers, matter numbers, meeting description data or other suitable data, the number of meetings associated with such data can be tabulated, the meeting data can be correlated to data from other data sources such as organization charts or other suitable processing can also or alternatively be performed. In a third exemplary embodiment, document management system data can be analyzed to identify data having collaborative indications, such as common authors or editors, client numbers, matter numbers, internal document data or other suitable data, the number of documents associated with such data can be tabulated, the document data can be correlated to data from other data sources such as organization charts or other suitable processing can also or alternatively be performed.

Target application 118 can receive provisioning data from migration engine 112, such as Contact lists for one or more groups, applications, or other suitable data, and can store the provisioning data in a user directory, user database or other suitable data structures. In one exemplary embodiment, target application 118 can have a configuration application programming interface that can be used to receive configuration data, migration engine 112 can be configured to access target application 118 using one or more macros or other suitable processes can also or alternatively be used.

In operation, system 100 is used to migrate users from one or more applications to a new application or suite of applications, such as Microsoft Office 365 or other suitable applications. System 100 can be configured to provision collaboration tools, applications or other suitable systems or processes.

FIG. 2 is a diagram of a user interface 200 for processing system migration data, in accordance with an exemplary embodiment of the present disclosure. User interface 200 includes application selection tool 204, relationship selection tool 206, project selection tool 208, function selection tool 210, match list display 212 and match item display 214, each of which can be implemented as one or more objects, each having state and associated textual, graphical and functional attributes.

Application selection tool 204 generates one or more user-selectable controls to allow selection of one or more associated applications for a user, to process collaboration data for a selected user. In one exemplary embodiment, each application (such as email, directory, calendar, document management) can be selected to generate a list in match list display 212 of other users that potentially have collaboration relationships with the current selected user. In this exemplary embodiment, the list on match list display 212 can include additional data specific to the selected application, such as email folders for an email application, project identifiers for a document management application, organizational data for a directory application, year or month for a calendar application and so forth. The user can also sort match lists by relevance, date, alphabetical order or in other suitable manners, can add or delete entries and can perform other suitable functions.

Relationship selection tool 206 generates one or more user-selectable controls to allow selection of one or more associated relationships for a user, to process collaboration data for a selected user. In one exemplary embodiment, each relationship (such as coworker, supervisor, subordinate) can be selected to generate a list in match list display 212 of other users that potentially have collaboration relationships with the current selected user. In this exemplary embodiment, the list on match list display 212 can include additional data specific to the selected relationship, such as coworkers, managers or subordinates within the same organization, coworkers, managers or subordinates within different organizations that have a functional relationship with the selected user's organization (such as a marketing organization associated with a product organization) and so forth. The user can also sort match lists by relevance, date, alphabetical order or in other suitable manners, can add or delete entries and can perform other suitable functions.

Project selection tool 208 generates one or more user-selectable controls to allow selection of one or more associated. projects for a user, to process collaboration data for a selected user. In one exemplary embodiment, each project (such as a client, a construction site, a product) can be selected to generate a list in match list display 212 of other users that potentially have collaboration relationships with the current selected user. In this exemplary embodiment, the list on match list display 212 can include additional data specific to the selected relationship, such as other coworkers that bill time to the same client, coworkers that are working at the same construction site, coworkers that are developing the same product and so forth. The user can also sort match lists by relevance, date, alphabetical order or in other suitable manners, can add or delete entries and can perform other suitable functions.

Function selection tool 210 generates one or more user-selectable controls to allow selection of one or more associated functions for a user, to process collaboration data for a selected user. In one exemplary embodiment, each function (such as engineering, marketing, legal) can be selected to generate a list in match list display 212 of other users that potentially have collaboration relationships with the current selected user. In this exemplary embodiment, the list on match list display 212 can include additional data specific to the selected relationship, such as engineering groups, marketing groups, legal departments and so forth. The user can also sort match lists by relevance, date, alphabetical order or in other suitable manners, can add or delete entries and can perform other suitable functions.

Match list display 212 allows a user to review recommended collaboration groups for selected applications, relationships, projects, functions or other suitable matches, and to sort the match lists by relevance, date, alphabetical order or in other suitable manners. Entries on the match list can be deleted, unlisted users can be located using search tools to be added to the match list, and other suitable functions can be provided. Match item display 214 can be used to display additional data about a user on the match list, such as to identify the user's affiliations (e.g. organizations, projects, products), to allow the user to identify other associated users that should be added to the collaboration work lists, and for other suitable purposes.

In operation, user interface 200 allows a user to perform system migration processing to identify associated users by application, relationship, project, function or in other suitable manners, to facilitate migration to a collaborative application or other associated applications. User interface 200 allows a user to generate ranked lists of other users that are suggested matches for collaboration groups, provides additional data for use in analyzing the other users on the lists and provides other suitable functions.

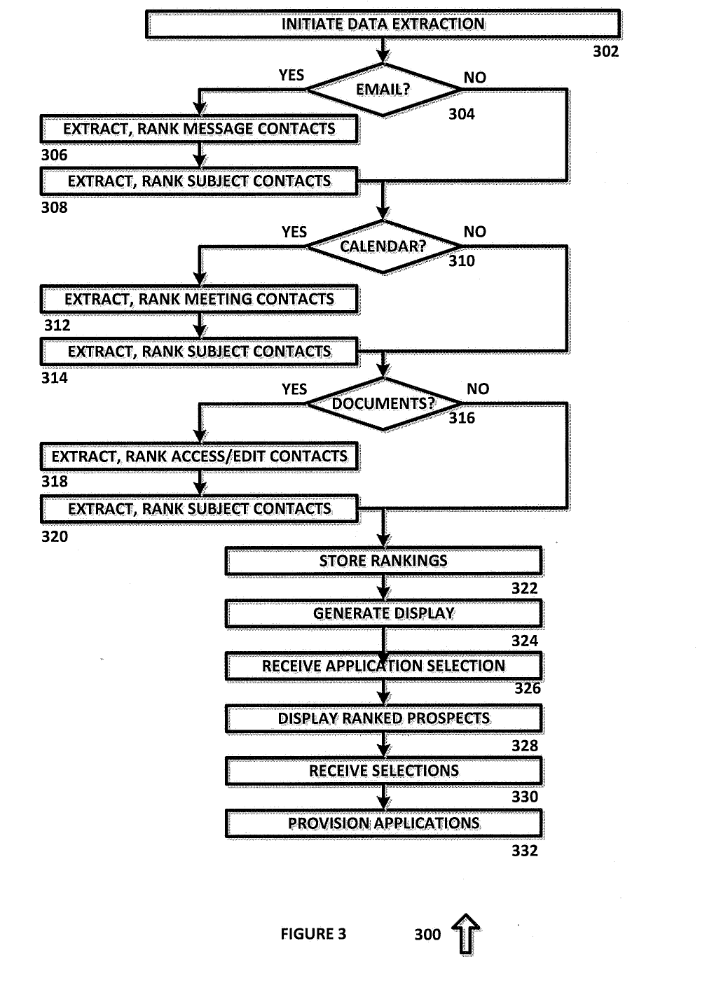

FIG. 3 is a flow chart of an algorithm 300 for processing system migration data, in accordance with an exemplary embodiment of the present disclosure. Algorithm 300 can be implemented in hardware or a suitable combination of hardware and software.

Algorithm 300 begins at 302, where data extraction is initiated for a system migration process. In one exemplary embodiment, data extraction can be performed for all users at the same time, can be performed for individual users or other suitable processes can also or alternatively be used. The algorithm then proceeds to 304.

At 304, it is determined whether an email application has been selected for processing. If an email application has not been selected, the algorithm proceeds to 310, otherwise the algorithm proceeds to 306 where email messages and other data are processed to extract message contacts, to rank message contacts and to perform other suitable functions. The algorithm then proceeds to 308 where the email messages are processed to extract subject-related contacts, to rank subject-related contacts and to perform other suitable functions, such as to identify additional potential contacts based on the subject matter of the emails. The algorithm then proceeds to 310.

At 310, it is determined whether a calendar application has been selected for processing. If a calendar application has not been selected, the algorithm proceeds to 316, otherwise the algorithm proceeds to 312 where calendar meeting entries are processed to extract meeting contacts, to rank meeting contacts and to perform other suitable functions. The algorithm then proceeds to 314 where the meeting subjects are processed to extract subject-related contacts, to rank subject-related contacts and to perform other suitable functions, such as to identify additional potential contacts based on the subject matter of the calendar entries. The algorithm then proceeds to 316.

At 316, it is determined whether a document management application has been selected for processing. If a document management application has not been selected, the algorithm proceeds to 322, otherwise the algorithm proceeds to 318 where the document management system data is processed to extract contacts that have accessed or edited the same documents, to rank document management system contacts and to perform other suitable functions. The algorithm then proceeds to 320 where the document data is processed to extract subject-related contacts, to rank subject-related contacts and to perform other suitable functions, such as to identify additional potential contacts based on the subject matter of the documents. The algorithm then proceeds to 322.

At 322, the rankings are stored in a relationship database, such as in dedicated folders for each user, for each source application, for each target application or in other suitable manners. The algorithm then proceeds to 324.

At 324, a user interface display is generated, such as on a user interface device of a migration manager, for a user associated with the extracted data or for other suitable users. The algorithm then proceeds to 326 where an application selection is received, such as in response to a selection by the user of an application from an application selection tool. Alternatively, a relationship selection, a project selection, a function selection or other suitable selections can also or alternatively be made. The algorithm then proceeds to 328.

At 328, ranked prospects for migration to a collaboration application or other suitable applications are displayed. In one exemplary embodiment, the prospects can be sorted by ranking, date, name or in other suitable manners. The algorithm then proceeds to 330 where selections are received from the ranked lists, and the ranked lists are stored in the relationship database. The algorithm then proceeds to 332, where the associated application or applications are provisioned.

In operation, algorithm 300 allows relationship data to be migrated from existing applications and data sources to new applications, such as for collaboration tools or other suitable purposes. Algorithm 300 allows data that is contained within data records such as emails, calendar entries, documents or other suitable records to be processed to identify collaboration relationships, to facilitate migration or for other suitable purposes. While email applications, calendar applications, document management applications and other applications are demonstrated in this exemplary embodiment, other suitable applications can also or alternatively be used.

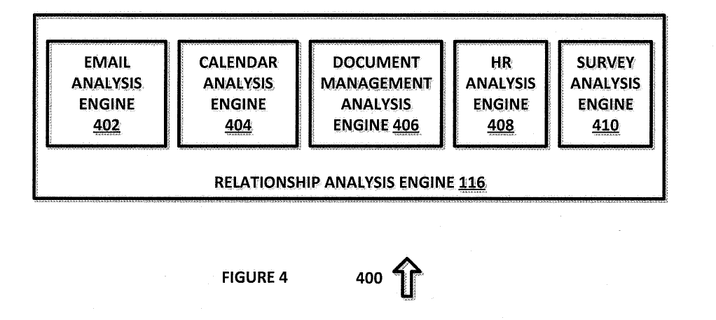

FIG. 4 is a diagram 400 of application analysis engines, in accordance with an exemplary embodiment of the present disclosure. Diagram 400 includes relationship analysis engine 116 and email analysis engine 402, calendar analysis engine 404, document management analysis engine 406, HR analysis engine 408 and survey analysis engine 410, each of which can be implemented in hardware or a suitable combination of hardware and software.

Email analysis engine 402 receives email data for a user or group of users and generates collaboration group data for the user or group of users. In one exemplary embodiment, email analysis engine 402 can receive email documents that include a sender field, one or more recipient fields (such as direct recipients, copied recipients, hidden copied recipients), a subject field, a date field, a project code field, a client identifier field, a product identifier field or other suitable data, and can evaluate the email documents for collaborative identifiers. In this exemplary embodiment, email analysis engine 402 can tabulate data for all of a user's emails, all of the user's emails that pertain to a specific subject field, all of the user's emails that pertain to a specific project field that identifies an associated project, all of the user's emails that pertain to a specific client field that identifies an associated client, all of the user's emails that pertain to a specific product field that identifies an associated product, and so forth. In another exemplary embodiment, email analysis engine 402 can tabulate data for all emails that pertain to a specific subject field for a plurality of users, for all emails that pertain to a specific project field for a plurality of users, for all emails that pertain to a specific client field for a plurality of users, for all emails that pertain to a specific product field for a plurality of users, and so forth, and can then use that email data for each of the plurality of users. Likewise, other suitable processes can also or alternatively be used.

Calendar analysis engine 404 receives calendar data for a user or group of users and generates recommended collaboration groups for the user or group of users. In one exemplary embodiment, calendar analysis engine 404 can receive calendar entries that include attendee fields, a subject field, a date field, a project code field, a client identifier field, a product identifier field or other suitable data, and can evaluate the calendar entries for collaborative identifiers. In this exemplary embodiment, calendar analysis engine 404 can tabulate data for all of a user's calendar entries, all of the user's calendar entries that pertain to a specific subject field, all of the user's calendar entries that pertain to a specific project field, all of the user's calendar entries that pertain to a specific client field, all of the user's calendar entries that pertain to a specific product field, and so forth. In another exemplary embodiment, calendar analysis engine 404 can tabulate data for all calendar entries that pertain to a specific subject field for a plurality of users, for all calendar entries that pertain to a specific project field for a plurality of users, for all calendar entries that pertain to a specific client field for a plurality of users, for all calendar entries that pertain to a specific product field for a plurality of users, and so forth, and can then use that calendar data for each of the plurality of users. Likewise, other suitable processes can also or alternatively be used.

Document management analysis engine 406 receives document management data for a user or group of users and generates collaboration group data for the user or group of users. In one exemplary embodiment, document analysis engine 406 can receive document management system data that include users that have created, accessed or edited a document, a subject field, a project code field, a client identifier field, a product identifier field, internal content fields or other suitable data, and can evaluate the document data for collaborative identifiers. In this exemplary embodiment, document management analysis engine 406 can tabulate data for all of a user's documents, all of the user's documents that pertain to a specific subject field, all of the user's documents that pertain to a specific project field, all of the user's documents that pertain to a specific client field, all of the user's documents that pertain to a specific product field, and so forth. In another exemplary embodiment, document management analysis engine 404 can tabulate data for all documents that pertain to a specific subject field for a plurality of users, for all documents that pertain to a specific project field for a plurality of users, for all documents that pertain to a specific client field for a plurality of users, for all documents that pertain to a specific product field for a plurality of users, and so forth, and can then use that document data for each of the plurality of users. Likewise, other suitable processes can also or alternatively be used.

HR analysis engine 408 receives human resources data for a user or group of users and generates collaboration group data for the user or group of users. In one exemplary embodiment, HR analysis engine 408 can receive organizational charts, directories, special programs data (such as mentors and mentees, members of project teams, members of marketing teams, members of product development teams) or other suitable data, and can evaluate the human resources data for collaborative identifiers. In this exemplary embodiment, HR analysis engine 408 can tabulate data for all of a user's human resources records, all of the user's human resources records that pertain to a specific subject field, all of the user's human resources records that pertain to a specific project field, all of the user's human resources records that pertain to a specific client field, all of the user's human resources records that pertain to a specific product field, and so forth. In another exemplary embodiment, HR analysis engine 408 can tabulate data for all human resources records that pertain to a specific subject field for a plurality of users, for all human resources records that pertain to a specific project field for a plurality of users, for all human resources records that pertain to a specific client field for a plurality of users, for all human resources records that pertain to a specific product field for a plurality of users, and so forth, and can then use that human resources records data for each of the plurality of users. Likewise, other suitable processes can also or alternatively be used.

Survey analysis engine 410 receives survey data for a user or group of users and generates collaboration group data for the user or group of users. In one exemplary embodiment, survey analysis engine 410 can receive survey responses for a user, a plurality of users or other suitable data, and can evaluate the survey data for collaborative identifiers. In this exemplary embodiment, survey analysis engine 410 can tabulate data for all of a user's survey responses, survey responses for a subset if users, survey responses for all users and so forth.

In another exemplary embodiment, survey analysis engine 410 can tabulate data for all survey responses that pertain to a specific subject field for a plurality of users, for all survey responses that pertain to a specific project field for a plurality of users, for all survey responses that pertain to a specific client field for a plurality of users, for all survey responses records that pertain to a specific product field for a plurality of users, and so forth, and can then use that survey data for each of the plurality of users. Likewise, other suitable processes can also or alternatively be used.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for processing data comprising:
a plurality of relationship data sources;
a migration engine operating on a processor or processors and coupled to the plurality of relationship data sources, the migration engine configured to query the plurality of relationship data sources and to receive query responses from the plurality of relationship data sources;
a relationship analysis engine operating on the processor or processors and coupled to the migration engine, the relationship analysis engine configured to receive the query response and to process the query responses to extract prospective collaboration data; and
a target application configured to receive the prospective collaboration data and to configure a user profile with the prospective collaboration data.

2. The system of claim 1 wherein the relationship analysis engine further comprises an application selection tool configured to receive application selection data and to process collaboration data as a function of the application selection data.

3. The system of claim 1 wherein the relationship analysis engine further comprises a relationship selection tool configured to receive relationship selection data and to process collaboration data as a function of the relationship selection data.

4. The system of claim 1 wherein the relationship analysis engine further comprises a project selection tool configured to receive project selection data and to process collaboration data as a function of the project selection data.

5. The system of claim 1 wherein the relationship analysis engine further comprises a function selection tool configured to receive function selection data and to process collaboration data as a function of the function selection data.

6. The system of claim 1 wherein the relationship analysis engine further comprises a match list display configured to receive collaboration data and to generate a list of identified collaborators and associated controls for manipulating the list of identified collaborators.

7. The system of claim 1 wherein the relationship analysis engine further comprises a match item display configured to receive collaboration data and to generate detail for an item on a list of identified collaborators.

8. The system of claim 1 wherein the relationship analysis engine further comprises an email system processing tool configured to receive email data and to identify one or more collaborators as a function of the email data.

9. The system of claim 1 wherein the relationship analysis engine further comprises a calendar system processing tool configured to receive calendar data and to identify one or more collaborators as a function of the calendar data.

10. The system of claim 1 wherein the relationship analysis engine further comprises a document management system processing tool configured to receive document management data and to identify one or more collaborators as a function of the document management data.

11. A method for processing data comprising:
querying each of a plurality of relationship data sources with a processor;
receiving query responses from the plurality of relationship data sources at the processor;
processing the query responses to extract prospective collaboration data using a plurality of automated rules;
receiving the prospective collaboration data at an application;
configuring a user profile with the prospective collaboration data.

12. The method of claim 11 further comprising:
receiving application selection data; and
processing the prospective collaboration data as a function of the application selection data to generate application-related prospective collaboration data.

13. The method of claim 11 further comprising:
receiving relationship selection data; and
processing the prospective collaboration data as a function of the relationship selection data to generate relationship-related prospective collaboration data.

14. The method of claim 11 further comprising:
receiving project selection data; and
processing the prospective collaboration data as a function of the project selection data to generate project-related prospective collaboration data.

15. The method of claim 11 further comprising:
receiving function selection data; and
processing the prospective collaboration data as a function of the function selection data to generate function-related prospective collaboration data.

16. The method of claim 11 further comprising:
receiving collaboration data; and
generating a list of identified collaborators and associated controls for manipulating the list of identified collaborators.

17. The method of claim 11 further comprising:
receiving collaboration data; and
generating detail for an item on a list of identified collaborators.

18. The method of claim 11 further comprising:
receiving email data; and
identifying one or more collaborators as a function of the email data.

19. The method of claim 11 further comprising:
receiving calendar data; and
identifying one or more collaborators as a function of the calendar data.

20. In a system for processing data having a plurality of relationship data sources, a migration engine operating on a processor or processors and coupled to the plurality of relationship data sources, the migration engine configured to query the plurality of relationship data sources and to receive query responses from the plurality of relationship data sources, a relationship analysis engine operating on the processor or processors and coupled to the migration engine, the relationship analysis engine configured to receive the query response and to process the query responses to extract prospective collaboration data, a target application configured to receive the prospective collaboration data and to configure a user profile with the prospective collaboration data, wherein the relationship analysis engine further comprises an application selection tool configured to receive application selection data and to process collaboration data as a function of the application selection data, wherein the relationship analysis engine further comprises a relationship selection tool configured to receive relationship selection data and to process collaboration data as a function of the relationship selection data, wherein the relationship analysis engine further comprises a project selection tool configured to receive project selection data and to process collaboration data as a function of the project selection data, wherein the relationship analysis engine further comprises a function selection tool configured to receive function selection data and to process collaboration data as a function of the function selection data, wherein the relationship analysis engine further comprises a match list display configured to receive collaboration data and to generate a list of identified collaborators and associated controls for manipulating the list of identified collaborators, wherein the relationship analysis engine further comprises a match item display configured to receive collaboration data and to generate detail for an item on a list of identified collaborators, wherein the relationship analysis engine further comprises an email system processing tool configured to receive email data and to identify one or more collaborators as a function of the email data, wherein the relationship analysis engine further comprises a calendar system processing tool configured to receive calendar data and to identify one or more collaborators as a function of the calendar data, wherein the relationship analysis engine further comprises a document management system processing tool configured to receive document management data and to identify one or more collaborators as a function of the document management data, a method comprising;
querying each of a plurality of relationship data sources with a processor;
receiving query responses from the plurality of relationship data sources at the processor;
processing the query responses to extract prospective collaboration data using a plurality of automated rules;
receiving the prospective collaboration data at an application;
configuring a user profile with the prospective collaboration data;
receiving application selection data;
processing the prospective collaboration data as a function of the application selection data to generate application-related prospective collaboration data;
receiving relationship selection data;
processing the prospective collaboration data as a function of the relationship selection data to generate relationship-related prospective collaboration data;
receiving project selection data;
processing the prospective collaboration data as a function of the project selection data to generate project-related prospective collaboration data;
receiving function selection data;
processing the prospective collaboration data as a function of the function selection data to generate function-related prospective collaboration data;
receiving collaboration data;
generating a list of identified collaborators and associated controls for manipulating the list of identified collaborators;
receiving collaboration data;
generating detail for an item on a list of identified collaborators;
receiving email data;
identifying one or more collaborators as a function of the email data;
receiving calendar data; and
identifying one or more collaborators as a function of the calendar data.
